(19) United States
(12) Patent Application Publication
(10) Pub. No.: US 2023/0333766 A1
(43) Pub. Date: Oct. 19, 2023

(54) MODIFIED COPY-ON-WRITE SNAPSHOTTING

(71) Applicant: VMware, Inc., Palo Alto, CA (US)

(72) Inventors: Enning XIANG, San Jose, CA (US); Wenguang WANG, Santa Clara, CA (US); Yiqi XU, Newark, CA (US); Yifan WANG, San Jose, CA (US); Fan NI, Fremont, CA (US)

(73) Assignee: VMware, Inc., Palo Alto, CA (US)

(21) Appl. No.: 17/724,456

(22) Filed: Apr. 19, 2022

(51) Int. Cl. G06F 3/06

(52) U.S. Cl. CPC G06F 3/0647; G06F 3/0655; G06F 3/0604; G06F 3/0679

(57) ABSTRACT

Example methods and systems for creating a plurality of snapshots of a storage object backed by a plurality of copy-on-write (COW) B+ tree data structure including a first COW B+ tree data structure having a first root node and leaf nodes maintaining mappings of LBAs to PBAs associated with a first snapshot of the storage object are disclosed. One example method includes creating a first root node of a first B+ tree data structure, maintaining a delta mapping table between a set of LBAs to a set of PBAs in the first leaf node, in response to receiving a request to create a second snapshot of the storage object: creating a second root node of a second COW B+ tree data structure and creating leaf nodes of the second COW B+ tree data structure in batches based on an order of the set of LBAs.

### BACKGROUND

Unless otherwise indicated herein, the approaches described in this section are not admitted to be prior art by inclusion in this section.

Virtualization allows the abstraction and pooling of hardware resources to support virtual machines (VMs) in a virtualized computing environment. For example, through server virtualization, virtualization computing instances such as VMs running different operating systems may be supported by the same physical machine (e.g., referred to as a “host”). Each VM is generally provisioned with virtual resources to run an operating system and applications. The virtual resources may include central processing unit (CPU) resources, memory resources, storage resources, network resources, etc.

In a distributed storage system, storage resources of a cluster of hosts may be aggregated to form a single shared pool of storage. VMs supported by the hosts within the cluster may then access the pool to store data. The data is stored and managed in a form of data containers called objects or storage objects. An object is a logical volume that has its data and metadata distributed in the distributed storage system. A virtual disk of a VM running on a host may also be an object and typically represented as a file in a file system of the host.

Snapshotting is a storage feature that allows for the creation of snapshots, which are point-in-time read-only copies of storage objects. Snapshots are commonly used for data backup, archival, and protection (e.g., crash recovery) purposes. Copy-on-write (COW) snapshotting is an efficient snapshotting implementation that generally involves (1) maintaining, for each storage object, a first B+ tree (referred to as a “logical map”) that keeps track of the storage object's state, and (2) at the time of taking a snapshot of the storage object, making the storage object's logical map immutable/read-only, designating this immutable logical map as the logical map of the snapshot, and creating a new logical map (e.g., a second B+ tree) for a running point (i.e., live) version of the storage object that includes a single root node of the second B+ tree pointing to the first level nodes of the first B+ tree (which allows the two B+ trees to share the same logical block address (LBA)-to-physical block address (PBA) mappings).

If a write is subsequently made to the storage object that results in a change to a particular LBA-to-PBA mapping, a copy of the leaf node in the snapshot's logical map (i.e., the first B+ tree) that holds the changed LBA-to-PBA mapping—as well as copies of any internal nodes between the leaf node and the root node—are created, and the new logical map of the running point version of the storage object is updated to point to the newly-created node copies, thereby separating it from the snapshot's logical map along that particular tree branch. The foregoing steps are then repeated as needed for further snapshots of, and modifications to, the storage object.

For a file system that supports multiple snapshots, data blocks may be shared among such snapshots, leading to inefficiencies associated with tracking and updating PBAs of such shared data blocks. Additional improvements are still needed to further enhance Input/Output (I/O) efficiencies.

### BRIEF DESCRIPTION OF DRAWINGS

FIG. 1 is a schematic diagram illustrating an example virtualized computing environment that supports COW snapshotting, according to one or more embodiments of the present disclosure;

FIG. 2 illustrates logical maps associated with a storage object used in a conventional COW snapshotting;

FIGS. 3A, 3B, 3C, 3D, 3E, 3F, 3G, 3H, 3I, 3J, 3K, and 3L each illustrates logical maps 300 associated with a storage object used in a modified COW snapshotting at a particular point in time, according to one or more embodiments of the present disclosure; and

FIG. 4 is a flow diagram of an example process for creating a plurality of snapshots of a storage object backed by a plurality of COW B+ tree data structure, according to one or more embodiments of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the drawings, can be arranged, substituted, combined, and designed in a wide variety of different configurations, all of which are explicitly contemplated herein. Although the terms “first” and “second” are used throughout the present disclosure to describe various elements, these elements should not be limited by these terms. These terms are used to distinguish one element from another. For example, a first element may be referred to as a second element, and vice versa.

In the disclosure, a “COW B+ tree” may refer to a B+ tree data structure which keeps track of a storage object's state, and at the time of taking a snapshot of the storage object, making the storage object's logical map immutable/read-only, designating this immutable logical map as the logical map of the snapshot, and making a root node of another COW B+ tree data structure for a running point version of the storage object pointing to the first level nodes of the B+ tree data structure. A “delta mapping” may refer to a mapping between a logical block address to one or more physical block addresses in response to a new write operation performed on a running point of a storage object. A “delta mapping table” may refer to a table including one or more delta mappings. The term “in batches” may refer to being in a small quantity or group at a time.

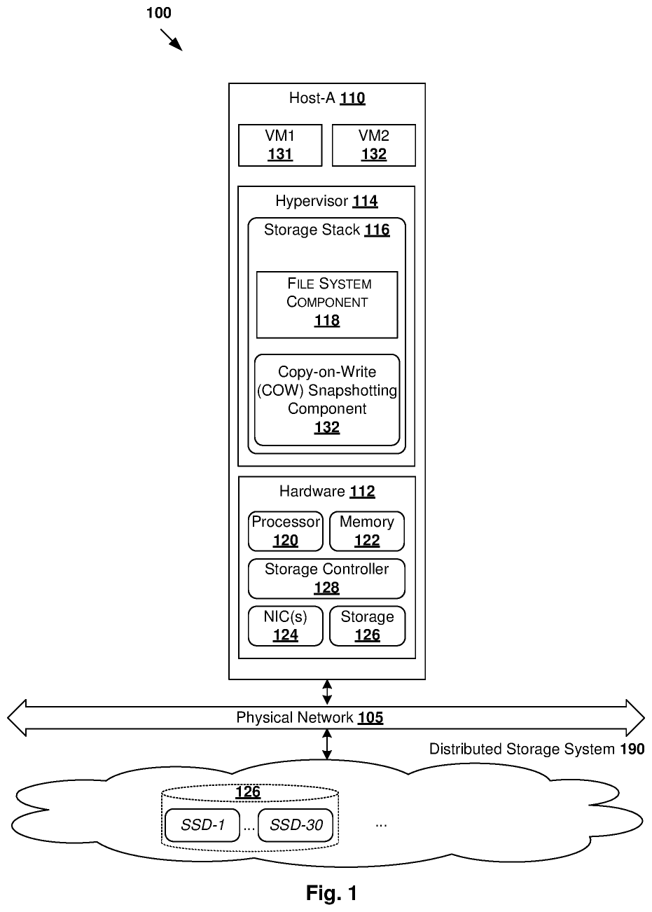

FIG. 1 is a schematic diagram illustrating an example virtualized computing environment that supports COW snapshotting, according to one or more embodiments of the present disclosure. It should be understood that, depending on the desired implementation, virtualized computing environment 100 may include additional and/or alternative components than that shown in FIG. 1.

In the example in FIG. 1, virtualized computing environment 100 includes one or more hosts that are inter-connected via physical network 105. For simplicity, only host 110 is illustrated. Host 110 includes suitable hardware 112 and virtualization software (e.g., hypervisor-A 114) to support various virtual machines (VMs) 131 and 132. In practice, virtualized computing environment 100 may include any number of hosts (also known as a “host computers”, “host devices”, “physical servers”, “server systems”, “transport nodes,” etc.), where each host may be supporting tens or hundreds of VMs.

It should be understood that a “virtual machine” running on a host is merely one example of a “virtualized computing instance” or “workload.” A virtualized computing instance may represent an addressable data compute node or isolated user space instance. In practice, any suitable technology may be used to provide isolated user space instances, not just hardware virtualization. Other virtualized computing instances may include containers (e.g., running within a VM or on top of a host operating system without the need for a hypervisor or separate operating system or implemented as an operating system level virtualization), virtual private servers, client computers, etc. Such container technology is available from, among others, Docker, Inc. The VMs may also be complete computational environments, containing virtual equivalents of the hardware and software components of a physical computing system. The term “hypervisor” may refer generally to a software layer or component that supports the execution of multiple virtualized computing instances, including system-level software in guest VMs that supports namespace containers such as Docker, etc.

Hypervisor 114 may be implemented any suitable virtualization technology, such as VMware ESX® or ESXi™ (available from VMware, Inc.), Kernel-based Virtual Machine (KVM), etc. Hypervisor 114 may also be a “type 2” or hosted hypervisor that runs on top of a conventional operating system on host 110.

Hypervisor 114 maintains a mapping between underlying hardware 112 and virtual resources allocated to respective VMs 131 and 132. Hardware 112 includes suitable physical components, such as central processing unit(s) or processor(s) 120; memory 122; physical network interface controllers (NICs) 124; storage resource(s) 126, storage controller(s) 128 to provide access to storage resource(s) 126, etc. Virtual resources are allocated to each VM to support a guest operating system (OS) and applications (not shown for simplicity). For example, corresponding to hardware 112, the virtual resources may include virtual CPU, guest physical memory (i.e., memory visible to the guest OS running in a VM), virtual disk, virtual network interface controller (VNIC), etc.

In practice, storage controller 128 may be any suitable controller, such as redundant array of independent disks (RAID) controller (e.g., RAID-0 or RAID-1 configuration), etc. Host 110 may include any suitable number of storage resources in the form of physical storage devices, drives or disks. Each physical storage resource may be housed in or directly attached to host 110. Example physical storage resources include solid-state drives (SSDs), Universal Serial Bus (USB) flash drives, etc. For example, SSDs are gaining popularity in modern storage systems due to relatively high performance and affordability. Depending on the desired implementation, each SSD may include a high-speed interface connected to a controller chip and multiple memory elements.

To implement Software-Defined Storage (SDS) in virtualized computing environment 100, host 110 and other hosts may be configured as a cluster. This way, all the hosts may aggregate their storage resources to form distributed storage system 190 that represents a shared pool of one or more storage resources 126. Distributed storage system 190 may employ any suitable technology, such as Virtual Storage Area Network (VSAN™) available from VMware, Inc. For example, host 110 and other hosts may aggregate respective storage resources into an “object store” (also known as a datastore or a collection of datastores). The object store represents a logical aggregated volume to store any suitable VM data relating to VMs 131 and 132, such as virtual machine disk (VMDK) objects, snapshot objects, swap objects, home namespace objects, etc. Any suitable disk format may be used, such as VM file system leaf level (VMFS-L), VSAN on-disk file system, etc. Distributed storage system 190 is accessible by hosts 110 via physical network 105.

In some embodiments, hypervisor 114 supports storage stack 116, which processes I/O requests that it receives. Storage stack 116 may include file system component 118 and copy-on-write (COW) snapshotting component 132. File system component 118 is configured to manage the storage of data in distributed storage system 190 and write data modifications to distributed storage system 190. File system component 118 can also accumulate multiple small write requests directed to different LBAs of a storage object in an in-memory buffer and, once the buffer is full, write out all of the accumulated write data (collectively referred to as a “segment”) via a single, sequential write operation.

COW snapshotting component 132 of storage stack 116 is configured to create snapshots of the storage objects supported by distributed storage system 190 by manipulating, via a copy-on-write mechanism, logical maps that keep track of the storage objects' states. A plurality of B+ tree data structures may be used in maintaining these logical maps.

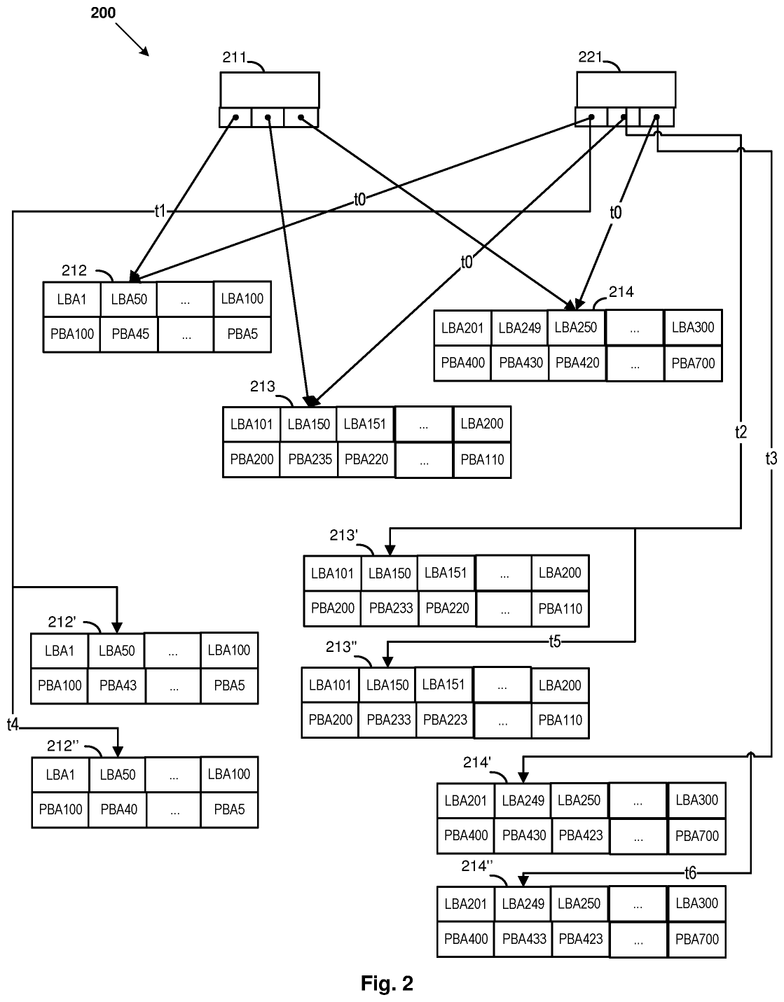

FIG. 2 illustrates logical maps 200 associated with a storage object used in a conventional COW snapshotting. Logical maps 200 includes first root node 211 of a first COW B+ tree data structure and second root node 221 of a second COW B+ tree data structure. First root node 211 is configured to point to leaf nodes 212, 213 and 214 of the first COW B+ tree data structure, which represents a first snapshot of the storage object. Second root node 221 is configured to point to leaf nodes 212, 213, 214, 212′, 213′, 214′, 212″, 213″, 214″ at different points in time, which represents a first running point version of the storage object at the different points in time.

Leaf node 212 is configured to maintain mappings of a first set of LBAs associated with a first memory page to a first set of PBAs. Assuming the first memory page includes 100 contiguous logical blocks and each of the logical blocks has its own block address mapping to one physical block address, leaf node 212 is configured to maintain mappings of LBA1 (i.e., logical block address of 1) to LBA100 (i.e., logical block address of 100), to their corresponding physical block addresses. For example, as illustrated in FIG. 2, LBA1 is mapped to PBA100 (i.e., physical block address of 100), LBA50 is mapped to PBA45 (i.e., physical block address of 45), LBA100 is mapped to PBA5 (i.e., physical block address of 5) and so on.

Similarly, leaf node 213 is configured to maintain mappings of a second set of LBAs associated with a second memory page to a second set of PBAs and leaf node 214 is configured to maintain mappings of a third set of LBAs associated with a third memory page to a third set of PBAs. Assuming the second memory page and the third memory page both include 100 contiguous logical blocks and each of the logical blocks has its own block address mapping to one physical block address, leaf node 213 is configured to maintain mappings of LBA101 (i.e., logical block address of 101) to LBA200 (i.e., logical block address of 200), to their mapped physical block addresses and leaf node 214 is configured to maintain mappings of LBA201 (i.e., logical block address of 201) to LBA300 (i.e., logical block address of 300), to their mapped physical block addresses.

For example, as illustrated in FIG. 2, LBA101 is mapped to PBA200 (i.e., physical block address of 200), LBA150 is mapped to PBA235 (i.e., physical block address of 235), LBA151 is mapped to PBA220 (i.e., physical block address of 220), LBA200 is mapped to PBA110 (i.e., physical block address of 110), and so on. In addition, LBA201 is mapped to PBA400 (i.e., physical block address of 400), LBA249 is mapped to PBA430 (i.e., physical block address of 430), LBA250 is mapped to PBA420 (i.e., physical block address of 420), LBA300 is mapped to PBA700 (i.e., physical block address of 700), and so on.

In response to creating the first snapshot of the storage object, at the beginning point in time, t0, a conventional COW snapshotting component is configured to make mapping maintained by leaf nodes 212, 213 and 214 immutable/read-only and designate these mappings as the logical map of the first snapshot. In addition, the COW snapshotting component is also configured to create second root node 221 and make second root node 221 point to mappings maintained by leaf nodes 212, 213 and 214 through internal nodes (not shown for simplicity). Second root node 221 is configured to track live version of the storage object in response to new writes to the storage object after the first snapshot is created.

In response to a first new write to LBA50, at a first point in time, t1, the COW snapshotting component is configured to copy all mappings maintained by leaf node 212 to generate leaf node 212′, update single mapping of LBA50 to PBA45 to the new mapping of LBA50 to PBA43 and make second root node 221 point to leaf node 212′.

In response to a second new write to LBA150, at a second point in time, t2, the COW snapshotting component is configured to copy all mappings maintained by leaf node 213 to generate leaf node 213′, update single mapping of LBA150 to PBA235 to the new mapping of LBA150 to PBA233 and make second root node 221 point to leaf node 213′. Assuming the COW snapshotting component only has two in-memory cache pages for buffering these updated mappings, the two in-memory cache pages are now fully occupied by updated mappings maintained by leaf nodes 212′ and 213′.

In response to a third new write to LBA250, at a third point in time, t3, because the in-memory cache pages are full, the COW snapshotting component is configured to evict mappings maintained by leaf node 212′, which causes a first write I/O cost. The COW snapshotting component is configured to copy all mappings maintained by leaf node 214 to generate leaf node 214′, update single mapping of LBA250 to PBA420 to the new mapping of LBA250 to PBA423 and make second root node 221 point to leaf node 213′.

In response to a fourth new write to LBA50, at a fourth point in time, t4, because the in-memory cache pages are full, the COW snapshotting component is configured to evict mappings maintained by leaf node 213′, which causes a second write I/O cost. The COW snapshotting component is configured to load mappings maintained by leaf node 212′ to generate lead node 212″, update single mapping of LBA50 to PBA43 to the new mapping of LBA50 to PBA40 and make second root node 221 point to leaf node 212″.

In response to a fifth new write to LBA151, at a fifth point in time, t5, because the in-memory cache pages are full, the COW snapshotting component is configured to evict mappings maintained by leaf node 214′, which causes a third write I/O cost. The COW snapshotting component is configured to load mappings maintained by leaf node 213′ to generate leaf node 213″, update single mapping of LBA151 to PBA200 to the new mapping of LBA151 to PBA223 and make second root node 221 point to leaf node 213″.

In response to a sixth new write to LBA249, at a sixth point in time, t6, because the in-memory cache pages are full, the COW snapshotting component is configured to evict mappings maintained by leaf node 212″, which causes a fourth write I/O cost. The COW snapshotting component is configured to load mappings maintained by leaf node 214′ to generate leaf node 214″, update single mapping of LBA249 to PBA430 to the new mapping of LBA249 to PBA433 and make second root node 221 point to leaf node 214″.

Lastly, dirty mappings maintained by leaf nodes 212′ and 213′ are flushed, which cause a fifth I/O cost and a sixth I/O cost, respectively. In response to creating a second snapshot of the storage object, the COW snapshotting component is configured to make mapping maintained by leaf nodes 212″, 213″ and 214″ immutable/read-only and designate these mappings as the logical map of the second snapshot. In addition, the COW snapshotting component is also configured to create a new root node (not shown in FIG. 2) and make new root node point to mappings maintained by leaf nodes 212″, 213″ and 214″ through internal nodes. Therefore, the conventional COW snapshotting component requires six I/O costs to process the six new writes to the storage object made after the first snapshot is created and before the second snapshot is created.

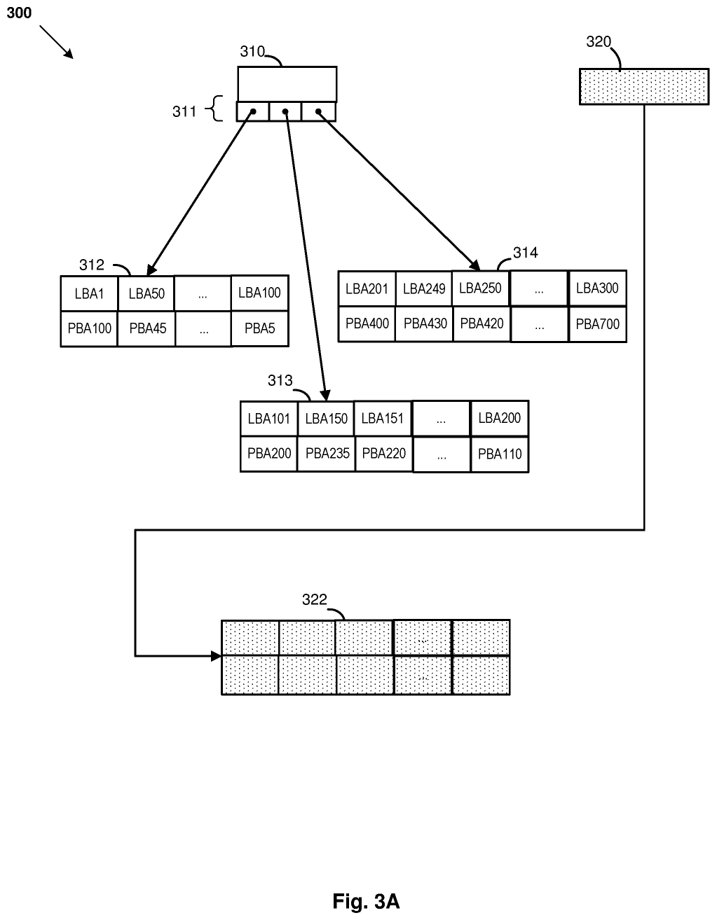

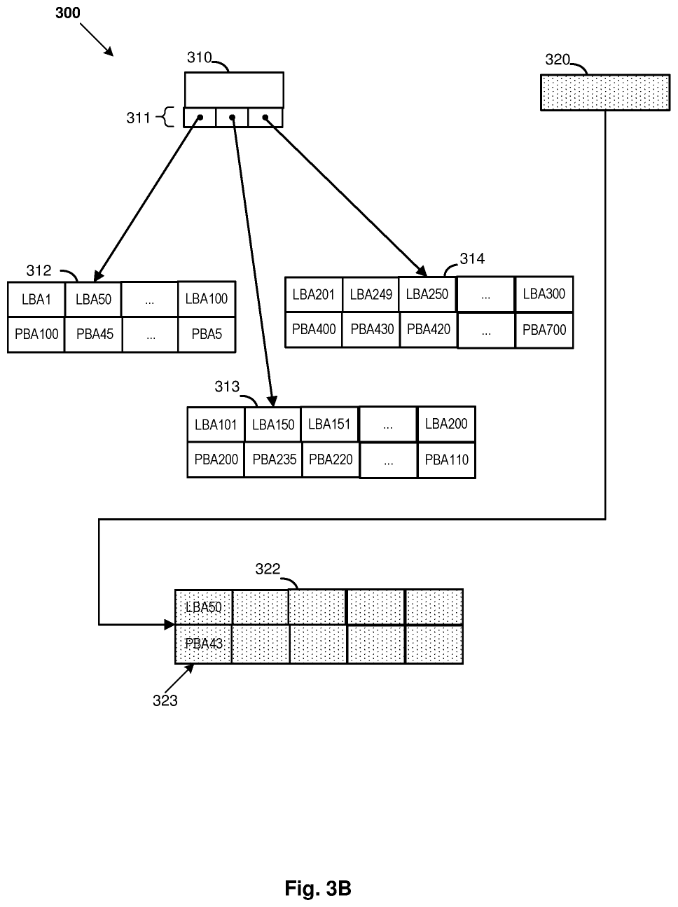

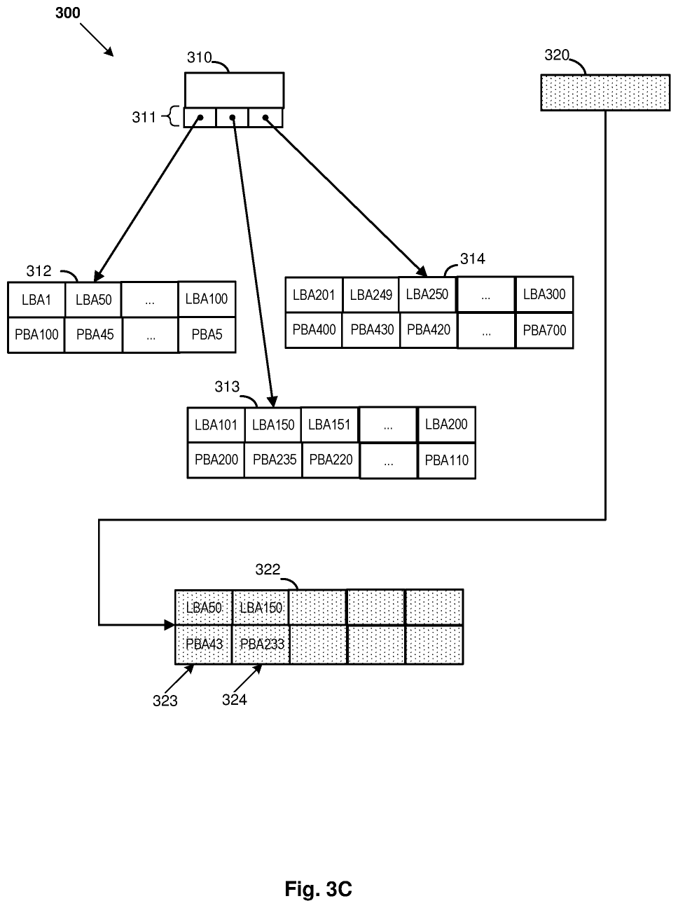

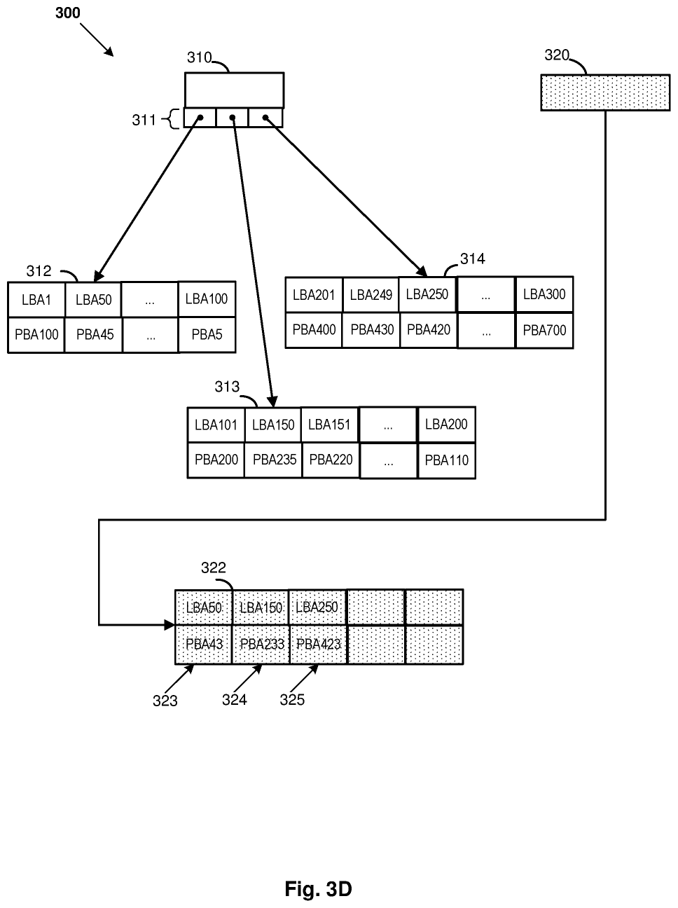

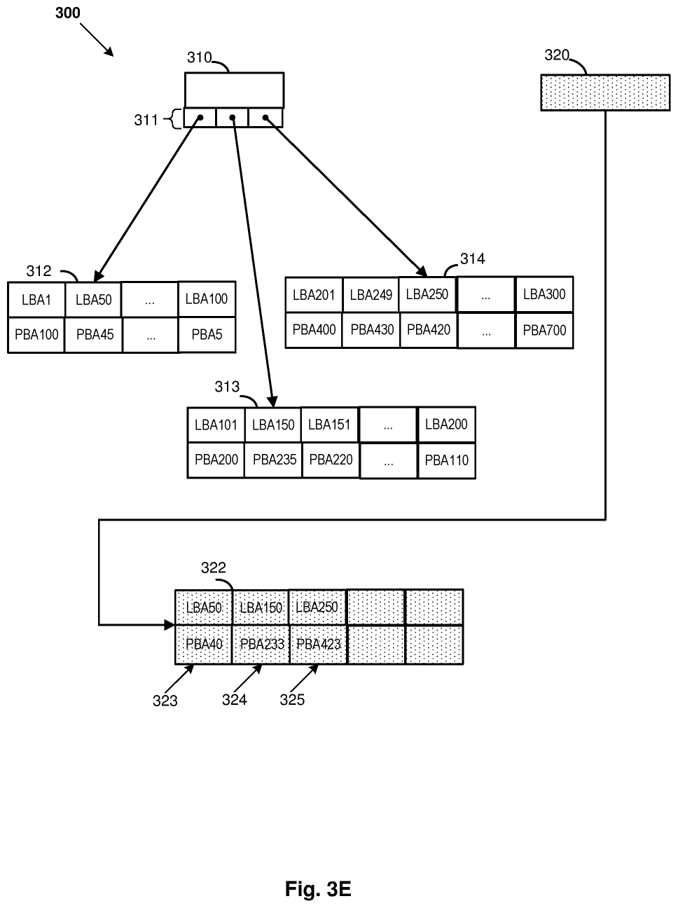

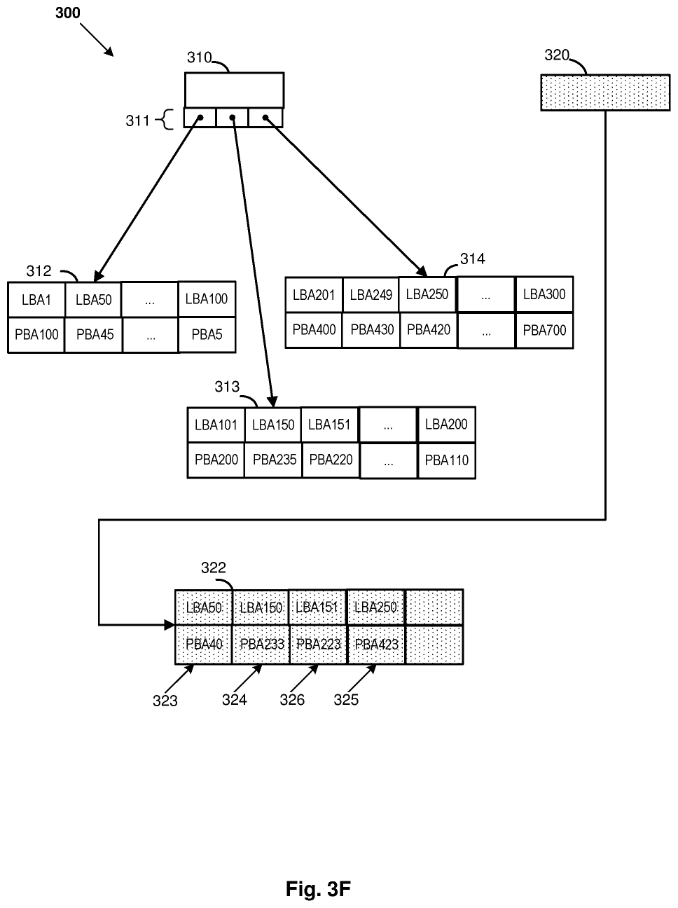

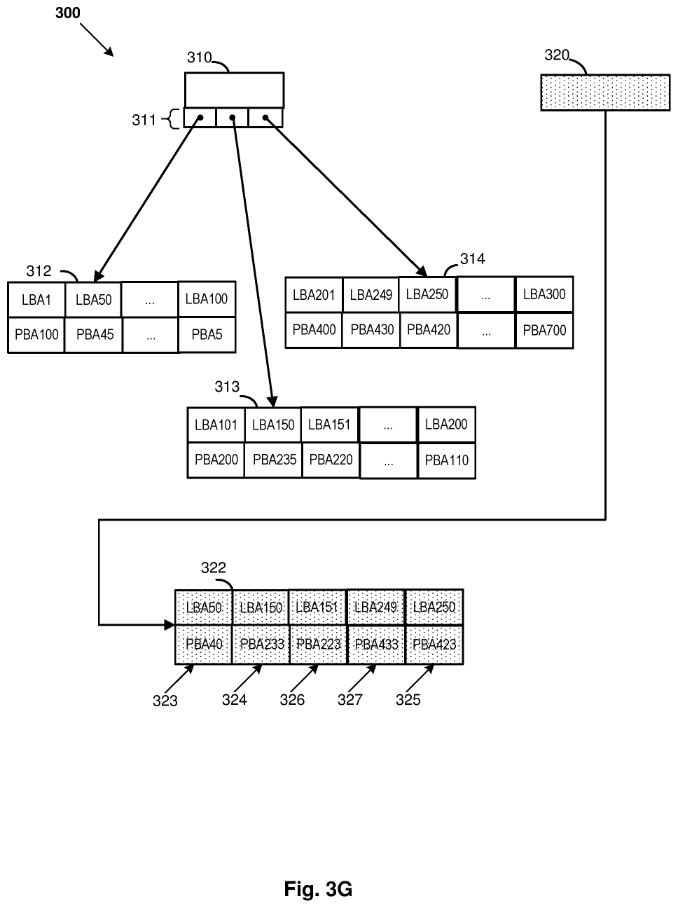

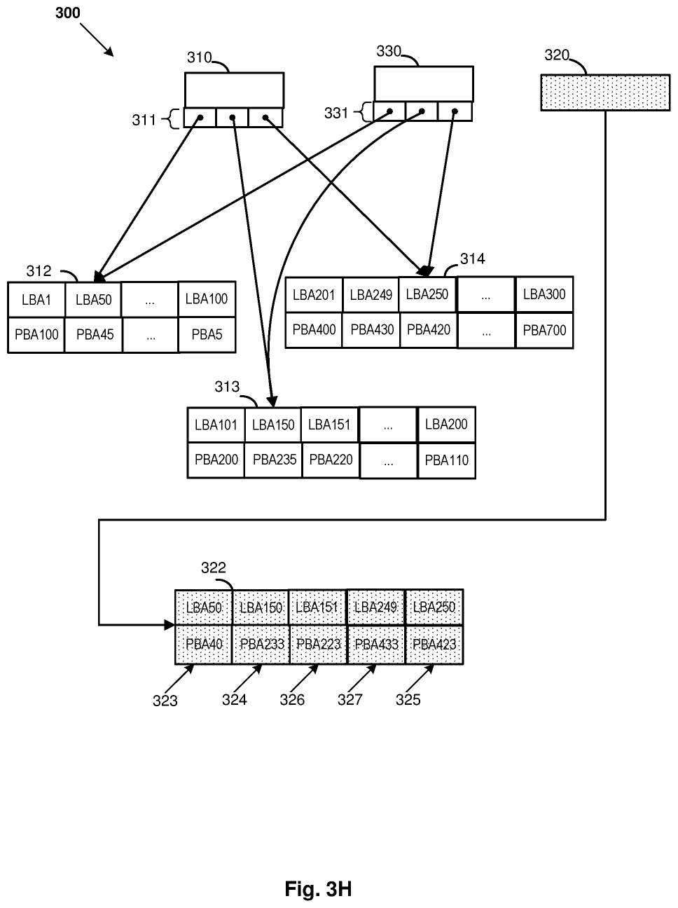

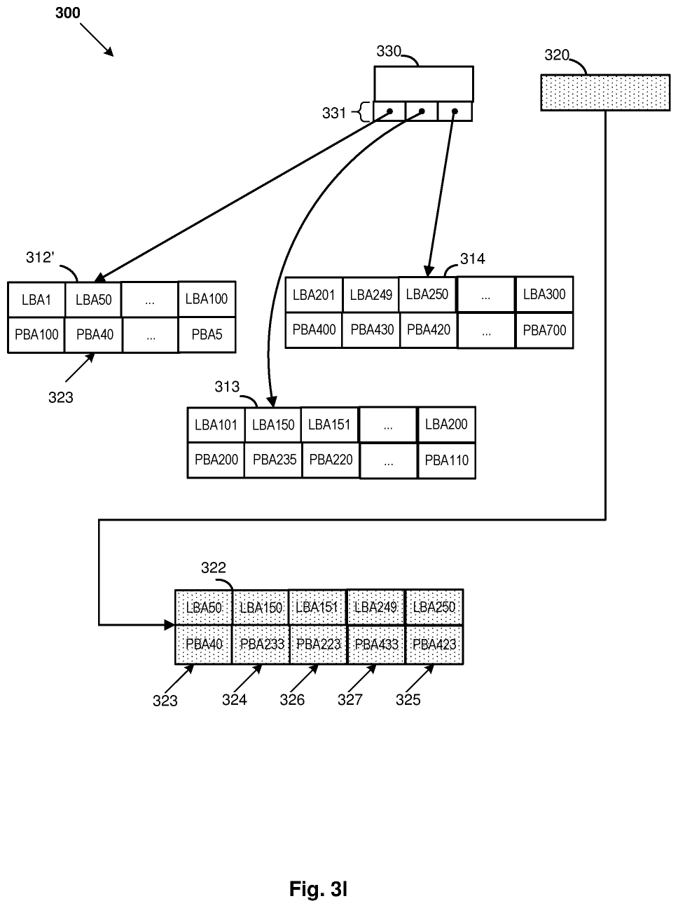

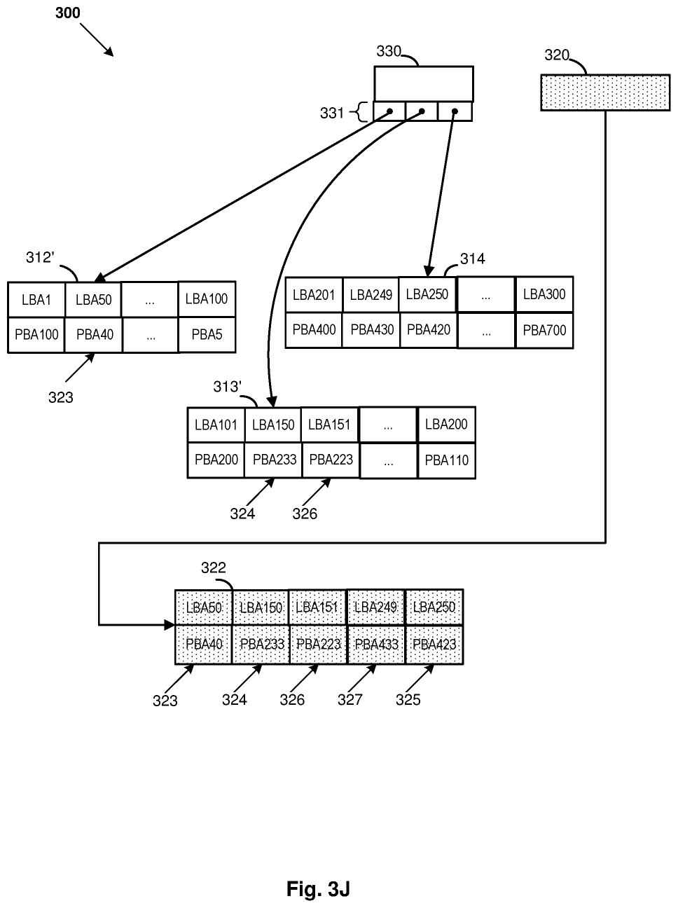

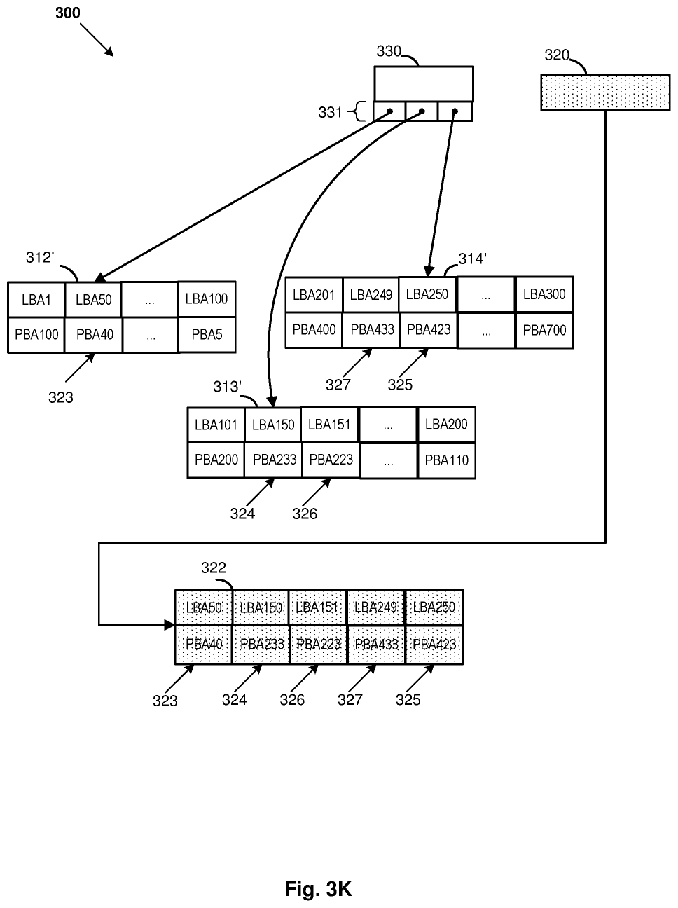

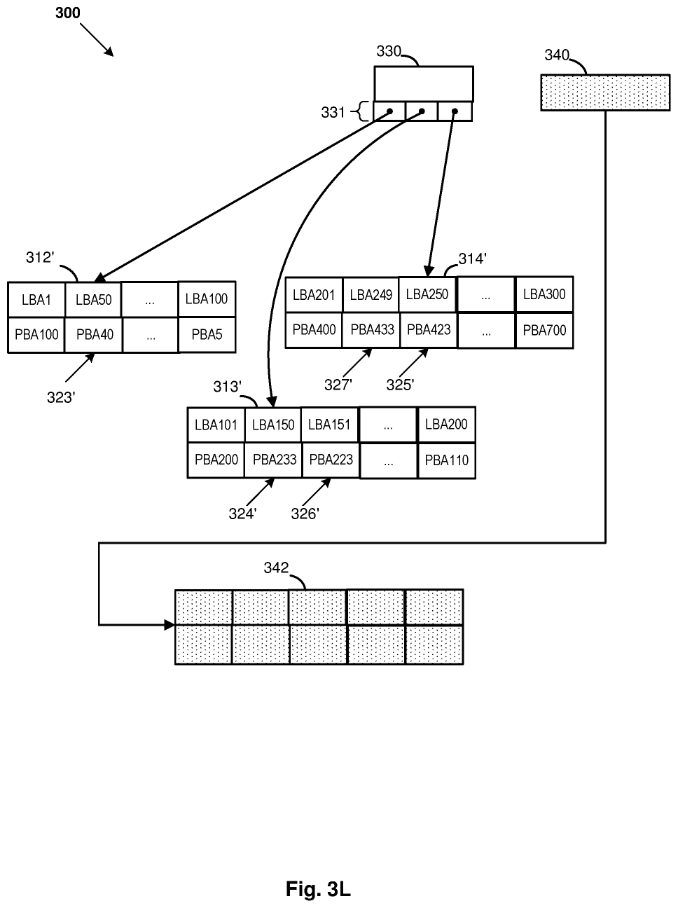

FIGS. 3A, 3B, 3C, 3D, 3E, 3F, 3G, 3H, 3I, 3J, 3K, and 3L each illustrates logical maps 300 associated with a storage object used in a modified COW snapshotting at a particular point in time, according to one or more embodiments of the present disclosure.

FIG. 3A illustrates logical map 300 associated with a storage object used in a modified COW snapshotting at a beginning point in time, such as t0′. In FIG. 3A, in some embodiments, root node 310 is the root node of a first COW B+ tree data structure. Root node 310 is configured to directly point to leaf nodes 312, 313 and 314 of the first COW B+ tree data structure, which represents a first snapshot of the storage object. Alternatively, root node 310 may also be configured to indirectly point to leaf nodes 312, 313 and 314 through internal nodes 311 of the first COW B+ tree data structure. In some embodiments, in conjunction with FIG. 2, leaf nodes 312, 313 and 314 correspond to leaf nodes 212, 213 and 214, respectively. In some embodiments, root node 320 is the root node of a first B+ tree data structure. Root node 320 is configured to point to leaf node 322 of the first B+ tree data structure, which represents a first running point version of the storage object. In this and the following figures, for clarity, the nodes associated with a B+ tree data structure (e.g., nodes 320 and 322) are represented by boxes with a dotted pattern, and the nodes associated with a COW B+ tree data structure (e.g., nodes 310, 311, 312, 313 and 314) are represented by boxes without any pattern.

In some embodiments, to create a first snapshot of the storage object at time t0′, in conjunction with FIG. 1, COW snapshotting component 132 is configured to make mappings maintained by leaf nodes 312, 313 and 314 immutable/read-only and designate these immutable mappings as the logical map of the first snapshot. In addition, COW snapshotting component 132 is also configured to create root node 320 and make root node 320 point to a leaf node 322 backed by the first B+ tree data structure. In some embodiments, root node 320 may directly point to lead node 322. In other embodiments, root 320 may indirectly point to leaf node 322 through internal nodes (not shown for simplicity) of the first B+ tree data structure. Root node 320 is configured to track the first running point version of the storage object in response to new writes to the storage object during or after the first snapshot is created. At time t0′, leaf node 322 maintains a delta mapping table with zero entry because there is no new write to the storage object.

FIG. 3B illustrates logical map 300 associated with the storage object used in the modified COW snapshotting at a first point in time, such as t1′. Here, time t1′ occurs after time t0′. In FIG. 3B, in some embodiments, in response to a first new write to LBA50, at time t1′, COW snapshotting component 132 is configured to add a first delta mapping 323 to the delta mapping table maintained by leaf node 322, which maps LBA50 to PBA43. “LBA50” refers to a logical block address with an integer index 50. “PBA43” refers to a physical block address with an integer index 43.

FIG. 3C illustrates logical map 300 associated with the storage object used in the modified COW snapshotting at a second point in time, such as t2′. Here, time t2′ occurs after time t1′. In FIG. 3C, in some embodiments, in response to a second new write to LBA150, at time t2′, COW snapshotting component 132 is configured to add a second delta mapping 324 to the delta mapping table maintained by leaf node 322, which maps LBA150 to PBA233. “LBA150” refers to a logical block address with an integer index 150. “PBA233” refers to a physical block address with an integer index 233.

FIG. 3D illustrates logical map 300 associated with the storage object used in the modified COW snapshotting at a third point in time, such as t3′. Here, time t3′ occurs after time t2′. In FIG. 3D, in some embodiments, in response to a third new write to LBA250, at time t3′, COW snapshotting component 132 is configured to add a third delta mapping 325 to the delta mapping table maintained by leaf node 322, which maps LBA250 to PBA423. “LBA250” refers to a logical block address with an integer index 250. “PBA423” refers to a physical block address with an integer index 423.

FIG. 3E illustrates logical map 300 associated with the storage object used in the modified COW snapshotting at a fourth point in time, such as t4′. Here, time t4′ occurs after time t3′. In FIG. 3E, in some embodiments, in response to a fourth new write to LBA50, at time t4′, COW snapshotting component 132 is configured to update previous delta mapping 323 of LBA50 to PBA43 to a current delta mapping 323 of LBA50 to PBA40. “PBA40” refers to a physical block address with an integer index 40.

FIG. 3F illustrates logical map 300 associated with the storage object used in the modified COW snapshotting at a fifth point in time, such as t5′. Here, time t5′ occurs after time t4′. In FIG. 3F, in some embodiments, in response to a fifth new write to LBA151, at time t5′, COW snapshotting component 132 is configured to insert a fourth delta mapping 326 to the delta mapping table maintained by leaf node 322, which maps LBA151 to PBA223. “LBA151” refers to a logical block address with an integer index 151. “PBA223” refers to a physical block address with an integer index 223.

FIG. 3G illustrates logical map 300 associated with the storage object used in the modified COW snapshotting at a sixth point in time, such as t6′. Here, time t6′ occurs after time t5′. In FIG. 3G, in some embodiments, in response to a sixth new write to LBA249, at time t6′, COW snapshotting component 132 is configured to insert a fifth delta mapping 327 to the delta mapping table maintained by leaf node 322, which maps LBA249 to PBA433. “LBA249” refers to a logical block address with an integer index 249. “PBA433” refers to a physical block address with an integer index 433.

For illustration purposes, in some embodiments, still assuming COW snapshotting component 132 only has two in-memory cache pages for buffering delta mappings maintained by leaf node 322, the delta mappings maintained by leaf node 322 may be cached in a first in-memory cache page of the two in-memory cache pages. In some embodiments, additional new writes to the storage object may continue and delta mappings associated with these new writes may be continuously maintained by leaf node 322.

FIG. 3H illustrates logical map 300 associated with the storage object used in the modified COW snapshotting at a seventh point in time, such as t7′. Here, time t7′ occurs after time t6′. In FIG. 3H, in some embodiments, in response to receiving a request to create a second snapshot of the storage object, at time t7′, COW snapshotting component 132 is configured to create a new root node 330. Root node 330 is the root node of a second COW B+ tree data structure. After root node 330 is created, COW snapshotting component 132 is also configured to create internal nodes 331 of the second COW B+ tree data structure. COW snapshotting component 132 may be configured to copy internal nodes 311 to create internal nodes 331. In addition to copying internal nodes 311, COW snapshotting component 132 may also be configured to create additional internal nodes 331 if these nodes are not included in internal nodes 311. COW snapshotting component 132 is then configured to make root node 330 directly point to all leaf nodes 312, 313 and 314 or indirectly point to leaf nodes 312, 313 and 314 through internal nodes 331.

In some embodiments, COW snapshotting component 132 is configured to create leaf nodes of the second COW B+ tree data structure in batches based on an order of the LBAs in delta mappings maintained by leaf node 322. The creation of leaf nodes in batches will be further described below in details.

FIG. 3I illustrates logical map 300 associated with the storage object used in the modified COW snapshotting at an eighth point in time, such as t8′. Here, time t8′ occurs after time t7′. In FIG. 3I, in some embodiments, at time t8′, based on the order of the integer indices of the LBAs (i.e., LBA50, LBA150, LBA151, LBA249 and LBA250) maintained by leaf node 322, COW snapshotting component 132 is configured to identify LBA50 maintained by leaf node 322 is between LBA1 and LBA100 and determine delta mapping 323 to be a first batch to process. In the first batch, COW snapshotting component 132 is configured to copy mappings maintained by leaf node 312 to generate leaf node 312′, update single mapping of LBA50 to PBA45 to the delta mapping 323 of LBA50 to PBA40 maintained by leaf node 322, make mappings maintained by leaf node 312′ read-only and make root node 330 directly point to leaf node 312′ or indirectly point to leaf node 312′ through internal nodes 331 and designate mappings maintained by leaf node 312′ as a part of a logical map of the second snapshot. The two memory cache pages that COW snapshotting component 132 can be used are now fully occupied by mappings maintained by leaf nodes 322 and 312′.

FIG. 3J illustrates logical map 300 associated with the storage object used in the modified COW snapshotting at a ninth point in time, such as t9′. Here, time t9′ occurs after time t8′. In FIG. 3J, in some embodiments, at time t9′, based on the order of the LBAs maintained by leaf node 322, COW snapshotting component 132 is configured to identify LBA150 and LBA151 maintained by leaf node 322 are between LBA101 and LBA200 and determine delta mappings 324 and 326 to be a second batch to process. In the second batch, COW snapshotting component 132 is configured to copy mappings maintained by leaf node 313 to generate leaf node 313′, update a first mapping of LBA150 to PBA235 to delta mapping 324 of LBA150 to PBA233 maintained by leaf node 322 and a second mapping of LBA151 to PBA220 to delta mapping 326 of LBA151 to PBA223 maintained by leaf node 322 and make mappings maintained by leaf node 313′ read-only. Because the two memory cache pages are full, COW snapshotting component 132 is configured to evict mappings maintained by leaf node 312′, which causes a first write I/O cost. COW snapshotting component 132 is configured to make root node 330 directly point to leaf node 313′ or indirectly point to leaf node 313′ through internal nodes 331 and designate mappings maintained by leaf node 313′ as a part of a logical map of the second snapshot.

FIG. 3K illustrates logical map 300 associated with the storage object used in the modified COW snapshotting at a tenth point in time, such as t10′. Here, time t10′ occurs after time t9′. In FIG. 3K, in some embodiments, at time t10′, based on the order of the LBAs maintained by leaf node 322, COW snapshotting component 132 is configured to identify LBA249 and LBA250 maintained by leaf node 322 are between LBA201 and LBA300 and determine delta mappings 327 and 325 to be a third batch to process. In the third batch, COW snapshotting component 132 is configured to copy mappings maintained by leaf node 314 to generate leaf node 314′, update a first mapping of LBA249 to PBA430 to delta mapping 327 of LBA249 to PBA433 maintained by leaf node 322 and a second mapping of LBA250 to PBA420 to delta mapping 325 of LBA250 to PBA423 maintained by leaf node 322 and make mappings maintained by leaf node 314′ read-only. Because the two memory cache pages are full, COW snapshotting component 132 is configured to evict mappings maintained by leaf node 313′, which causes a second write I/O cost. COW snapshotting component 132 is configured to make root node 330 directly point to leaf node 314′ or indirectly point to leaf node 314′ through internal nodes 331 and designate mappings maintained by leaf node 314′ as a part of a logical map of the second snapshot.

FIG. 3L illustrates logical map 300 associated with the storage object used in the modified COW snapshotting at an eleventh point in time, such as t11′. Here, time t11′ occurs after time t10′. Lastly, in some embodiments, in FIG. 3L, delta mappings maintained by leaf node 322 are flushed, which cause a third I/O cost. In some embodiments, COW snapshotting component 132 is configured to create a new root node 340. Root node 340 is the root node of a second B+ tree data structure. COW snapshotting component 132 is configured to make root node 340 directly point to a leaf node 342 or indirectly point to the leaf node 342 through internal nodes backed by a second B+ tree data structure. Root node 340 is configured to track a second running point version of the storage object in response to new writes to the storage object. In some embodiments, the creation of the second snapshot (i.e., operations illustrated in FIG. 3H to 3K) may be performed during leaf node 342 maintains/updates mappings associated with new writes to the second running point version of the storage object. Compared to conventional COW snapshotting, the modified COW snapshotting illustrated in FIG. 3A to 3L requires less I/O write costs.

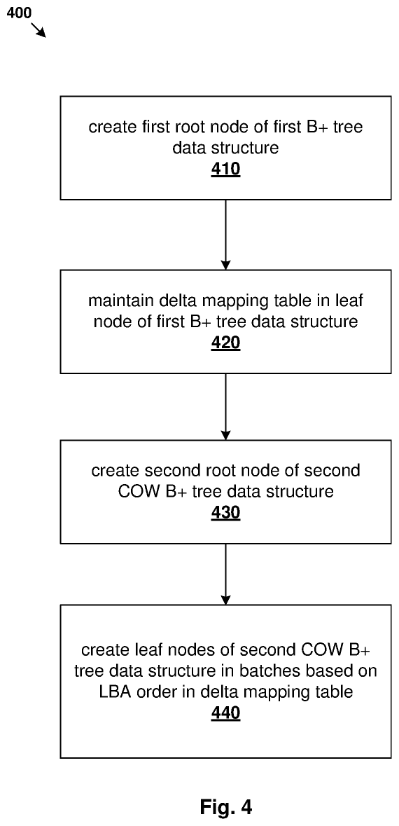

FIG. 4 is a flow diagram of an example process 400 for creating a plurality of snapshots of a storage object backed by a plurality of COW B+ tree data structure, according to one or more embodiments of the present disclosure. Example process 400 may include one or more operations, functions, or actions illustrated by one or more blocks, such as 410 to 440. The various blocks may be combined into fewer blocks, divided into additional blocks, and/or eliminated depending on the desired implementation. In some embodiments, process 400 may be performed by COW snapshotting component 132 illustrated in FIG. 1.

Process 400 may start with block 410 “create first root node of first B+ tree data structure.” For example, in conjunction with FIG. 3A at t0′, in block 410, COW snapshotting component 132 is configured to create root node 320 of a first B+ tree data structure to directly or indirectly point to leaf node 322 of the first B+ tree data structure, which represents a first running point version of the storage object. Block 410 may be followed by block 420 “maintain delta mapping table in leaf node of first B+ tree data structure.”

In some embodiments, in conjunction with FIGS. 3B, 3C, 3D, 3E, 3F, and 3G, in block 420, COW snapshotting component 132 is configured to maintain delta mappings in the delta mapping table backed by leaf node 322 at t1′ to t6′ set forth above. Block 420 may be followed by block 430 “create second root node of second COW B+ tree data structure.”

In some embodiments, in conjunction with FIG. 3H, in block 430, COW snapshotting component 132 is configured to create root node 330 of a second COW B+ tree data structure at t7′ set forth above. Root node 330 directly point to leaf nodes 312, 313 and 314 or indirectly point to leaf nodes 312, 313 and 314 through internal nodes 331. Block 430 may be followed by block 440 “create leaf nodes of second COW B+ tree data structure in batches based on LBA order in delta mapping table.”

In some embodiments, in conjunction with FIGS. 3I, 3J, and 3K, in block 440, COW snapshotting component 132 is configured to generate leaf nodes 312′, 313′ and 314′ based on delta mappings maintained by leaf node 322 in batches at t8′, t9′ and t10′ set forth above. COW snapshotting component 132 is configured to designate mappings maintained by leaf nodes 312′, 313′ and 314′ as the logical map of the second snapshot set forth above.

The above examples can be implemented by hardware (including hardware logic circuitry), software or firmware or a combination thereof. The above examples may be implemented by any suitable computing device, computer system, etc. The computer system may include processor(s), memory unit(s) and physical NIC(s) that may communicate with each other via a communication bus, etc. The computer system may include a non-transitory computer-readable medium having stored thereon instructions or program code that, when executed by the processor, cause the processor to perform processes described herein with reference to FIG. 1 to FIG. 4. For example, a computer system capable of acting as host 110 may be deployed in virtualized computing environment 100.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term ‘processor’ is to be interpreted broadly to include a processing unit, ASIC, logic unit, or programmable gate array etc.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or any combination thereof.

Those skilled in the art will recognize that some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

Software and/or to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, SSDs, etc.).

The drawings are only illustrations of an example, wherein the units or procedure shown in the drawings are not necessarily essential for implementing the present disclosure. Those skilled in the art will understand that the units in the device in the examples can be arranged in the device in the examples as described, or can be alternatively located in one or more devices different from that in the examples. The units in the examples described can be combined into one module or further divided into a plurality of sub-units.

We claim:

1. A method for creating a plurality of snapshots of a storage object backed by a plurality of copy-on-write (COW) B+ tree data structures including a first COW B+ tree data structure having a first root node, internal nodes and leaf nodes maintaining mappings of logical block addresses (LBAs) to physical block addresses (PBAs) associated with a first snapshot of the storage object, comprising:
creating a first root node of a first B+ tree data structure, wherein the first root node directly or indirectly points to a first leaf node of the first B+ tree data structure;
in response to one or more new writes to the storage object, maintaining a delta mapping table between a set of LBAs to a set of PBAs in the first leaf node;
in response to receiving a request to create a second snapshot of the storage object:
creating a second root node of a second COW B+ tree data structure, wherein the second root node of the second COW B+ tree data structure directly or indirectly points to the leaf nodes of the first COW B+ tree data structure; and
creating leaf nodes of the second COW B+ tree data structure in batches based on an order of the set of LBAs, wherein the leaf nodes of the second Cow B+ tree data structure is configured to maintain one or more delta mappings in the delta mapping table to be read-only as a logical map of the second snapshot.

2. The method of claim 1, wherein maintaining the delta mapping table between the set of LBAs to the set of PBAs in the first leaf node further comprises adding, updating or inserting a delta mapping in the delta mapping table based on the order of the set of LBAs.

3. The method of claim 1, further comprising creating internal nodes of the second COW B+ tree data structure after creating the second root node of the second COW B+ tree data structure.

4. The method of claim 3, further comprising making the second root node of the second COW B+ tree data structure point to the leaf nodes of the second COW B+ tree data structure, instead of the leaf nodes of the first COW B+ tree data structure, through the internal nodes of the second COW B+ tree data structure.

5. The method of claim 1, wherein creating leaf nodes of the second COW B+ tree data structure in batches includes creating a first leaf node of the second COW B+ tree data structure in a first batch and a second leaf node of the second COW B+ tree data structure in a second batch performed after the first batch.

6. The method of claim 5, wherein the first batch is associated with a first LBA with a first integer index in the delta mapping table and the second batch is associated with a second LBA with a second integer index in the delta mapping table, and the first integer index is less than the second integer index.

7. The method of claim 6, wherein creating the first leaf node of the second COW B+ tree data structure in the first batch includes copying mappings of LBAs to PBAs maintained by a first leaf node of the first COW B+ tree data structure, updating the mappings based on a delta mapping associated with the first LBA in the delta mapping table and making the updated mappings read-only as a part of the logical map of the second snapshot.

8. A non-transitory computer-readable storage medium that includes a set of instructions which, in response to execution by a processor of a computer system, cause the processor to perform a method for creating a plurality of snapshots of a storage object backed by a plurality of COW B+ tree data structures including a first COW B+ tree data structure having a first root node, internal nodes and leaf nodes maintaining mappings of LBAs to PBAs associated with a first snapshot of the storage object, the method comprising:
creating a first root node of a first B+ tree data structure, wherein the first root node directly or indirectly points to a first leaf node of the first B+ tree data structure;
in response to one or more new writes to the storage object, maintaining a delta mapping table between a set of LBAs to a set of PBAs in the first leaf node;
in response to receiving a request to create a second snapshot of the storage object:
creating a second root node of a second COW B+ tree data structure, wherein the second root node of the second COW B+ tree data structure directly or indirectly points to the leaf nodes of the first COW B+ tree data structure; and
creating leaf nodes of the second COW B+ tree data structure in batches based on an order of the set of LBAs, wherein the leaf nodes of the second Cow B+ tree data structure is configured to maintain one or more delta mappings in the delta mapping table to be read-only as a logical map of the second snapshot.

9. The non-transitory computer-readable storage medium of claim 8, wherein maintaining the delta mapping table between the set of LBAs to the set of PBAs in the first leaf node further comprises adding, updating or inserting a delta mapping in the delta mapping table based on the order of the set of LBAs.

10. The non-transitory computer-readable storage medium of claim 9, including additional instructions which, in response to execution by the processor of the computer system, cause the processor to:
create internal nodes of the second COW B+ tree data structure after creating the second root node of the second COW B+ tree data structure.

11. The non-transitory computer-readable storage medium of claim 10, including additional instructions which, in response to execution by the processor of the computer system, cause the processor to:
make the second root node of the second COW B+ tree data structure point to the leaf nodes of the second COW B+ tree data structure, instead of the leaf nodes of the first COW B+ tree data structure, through the internal nodes of the second COW B+ tree data structure.

12. The non-transitory computer-readable storage medium of claim 8, wherein creating leaf nodes of the second COW B+ tree data structure in batches includes creating a first leaf node of the second COW B+ tree data structure in a first batch and a second leaf node of the second COW B+ tree data structure in a second batch performed after the first batch.

13. The non-transitory computer-readable storage medium of claim 12, wherein the first batch is associated with a first LBA with a first integer index in the delta mapping table and the second batch is associated with a second LBA with a second integer index in the delta mapping table, and the first integer index is less than the second integer index.

14. The non-transitory computer-readable storage medium of claim 13, wherein creating the first leaf node of the second COW B+ tree data structure in the first batch includes copying mappings of LBAs to PBAs maintained by a first leaf node of the first COW B+ tree data structure, updating the mappings based on a delta mapping associated with the first LBA in the delta mapping table and making the updated mappings read-only as a part of the logical map of the second snapshot.

15. A computer system configured to create a plurality of snapshots of a storage object backed by a plurality of COW B+ tree data structures including a first COW B+ tree data structure having a first root node, internal nodes and leaf nodes maintaining mappings of LBAs to PBAs associated with a first snapshot of the storage object, comprising:
a processor; and
a non-transitory computer-readable medium having stored thereon instructions that, when executed by the processor, cause the processor to:
create a first root node of a first B+ tree data structure, wherein the first root node directly or indirectly points to a first leaf node of the first B+ tree data structure;
in response to one or more new writes to the storage object, maintain a delta mapping table between a set of LBAs to a set of PBAs in the first leaf node;
in response to receiving a request to create a second snapshot of the storage object:
create a second root node of a second COW B+ tree data structure, wherein the second root node of the second COW B+ tree data structure directly or indirectly points to the leaf nodes of the first COW B+ tree data structure; and
create leaf nodes of the second COW B+ tree data structure in batches based on an order of the set of LBAs, wherein the leaf nodes of the second Cow B+ tree data structure is configured to maintain one or more delta mappings in the delta mapping table to be read-only as a logical map of the second snapshot.

16. The computer system of claim 15, wherein maintaining the delta mapping table between the set of LBAs to the set of PBAs in the first leaf node further comprises adding, updating or inserting a delta mapping in the delta mapping table based on the order of the set of LBAs.

17. The computer system of claim 16, wherein the non-transitory computer-readable medium has stored thereon additional instructions that, when executed by the processor, cause the processor to:
create internal nodes of the second COW B+ tree data structure after creating the second root node of the second COW B+ tree data structure.

18. The computer system of claim 17, wherein the non-transitory computer-readable medium has stored thereon additional instructions that, when executed by the processor, cause the processor to:
make the second root node of the second COW B+ tree data structure point to the leaf nodes of the second COW B+ tree data structure, instead of the leaf nodes of the first COW B+ tree data structure, through the internal nodes of the second COW B+ tree data structure.

19. The computer system of claim 15, wherein creating leaf nodes of the second COW B+ tree data structure in batches includes creating a first leaf node of the second COW B+ tree data structure in a first batch and a second leaf node of the second COW B+ tree data structure in a second batch performed after the first batch.

20. The computer system of claim 19, wherein the first batch is associated with a first LBA with a first integer index in the delta mapping table and the second batch is associated with a second LBA with a second integer index in the delta mapping table, and the first integer index is less than the second integer index.

21. The computer system of claim 20, wherein creating the first leaf node of the second COW B+ tree data structure in the first batch includes copying mappings of LBAs to PBAs maintained by a first leaf node of the first COW B+ tree data structure, updating the mappings based on a delta mapping associated with the first LBA in the delta mapping table and making the updated mappings read-only as a part of the logical map of the second snapshot.
